(19) United States
(12) Patent Application Publication
(10) Pub. No.: US 2005/0038153 A1
(43) Pub. Date: Feb. 17, 2005

(54) Method for the production of polycondensates

(76) Inventors: Eric Richter, Thierhaupten (DE); Christian Lechner, Hurlach (DE); Rainer Bott, Seeth-Ekholt (DE)

Correspondence Address: CLARIANT CORPORATION;INTELLECTUAL PROPERTY DEPARTMENT, 4000 MONROE ROAD, CHARLOTTE, NC, 28205, US

(21) Appl. No.: 10/493,187

(22) PCT Filed: Oct. 10, 2002
(86) PCT No.: PCT/EP02/11332

(30) Foreign Application Priority Data
Oct. 20, 2001 (DE) 10152229.0

(51) Int. Cl. C08G 69/26

(52) U.S. Cl. 524/275

(57) ABSTRACT

A method for the production of polycondensates. The method is characterized in that waxes and polymer additives are used as lubricating and separating agents during the production of the polycondensate.

The invention relates to a process for preparing polycondensates. Plastics are usually processed in the melt. The associated changes in structure and state (e.g. crosslinking, oxidation, molecular weight changes) cause some alteration in the chemical, physical, and technical properties of almost every plastic. To reduce the stress to which plastics are exposed during their processing, various additives are used, among which are stabilizers, lubricants, antioxidants, release agents, dispersing agents, and others.

The sole use of various waxes as (mold-)release agents in plastics is known in various plastics, in particular in polyamides. (Mold-)release agents often used are metal stearates, amide waxes, and montan wax esters.

Although the metal stearates improve the flowability of the melt, they often cause considerable molecular-weight degradation of the polymers. Montan wax esters and their salts improve the flowability of plastics, such as polyamides, solely through internal lubricant action, without reducing the molecular weight of the polymer.

Coloring, especially of polyamide, is rendered particularly difficult by the high processing temperatures, and also by the chemically aggressive nature of the melt toward colorants, and there is a very restricted choice of colorants (pigments) and dispersing agents which may be used. Pigments often sustain lasting degradation due to the high added shear-energy levels present during the dispersion process. The dispersing agents, too, have to be optimized.

Montan waxes or amide waxes have previously been used as dispersing agents for pigments.

In principle, it is also possible to stabilize plastics in a downstream process, but the homogenization achieved is often insufficient, especially if a pulverulent stabilizer is added to the plastics pellets.

Among the materials which have proven successful for stabilizing many plastics, in particular polyamides, with respect to air, light, and heat are copper salts, aromatic amines, and sterically hindered phenols.

The abovementioned auxiliaries or agents may be introduced into the plastic at a very wide variety of steps in the process, for example at the end of the polycondensation, or in a subsequent compounding process. It is also possible to apply pulverulent waxes to the (warm) plastics pellets in a drum mixer.

The prior-art action of the various agents and auxiliaries in plastics preparation, in particular preparation of polycondensates, listed remains inadequate with respect to a number of properties, such as internal and external lubricant action, and also dispersion of pigments and fillers, and the gloss of the plastic.

It was therefore an object of the present invention to provide auxiliaries or agents which have improved overall action on the plastic, in particular in the case of polyamides, in plastics preparation, in particular preparation of polycondensates.

This object is achieved by way of a process of the type mentioned at the outset, which comprises using waxes and polymer additives as lubricants and release agents, and as dispersing agents, during the preparation of the polycondensate.

Surprisingly, it has been found that, when comparison is made with the use of the individual substances, and also with a number of other waxes, the synergistic effects of waxes and polymer additives gives the best results, in particular in polyamides, in relation to internal and external lubricant action, and also dispersion of pigments and fillers, and gloss, in the process for preparing polycondensates.

A preferred wax is an ester wax and/or a salt of a carboxylic acid.

Another preferred wax is products of the reaction of montan wax acids with ethylene glycol.

The products of the reaction are preferably a mixture of the mono(montan wax acid) ester of ethylene glycol, the di(montan wax acid) ester of ethylene glycol, montan wax acids, and ethylene glycol. Another preferred wax is products of the reaction of montan wax acids with a calcium salt.

The products of the reaction are particularly preferably a mixture of the mono(montan wax acid) ester of 1,3-butanediol, the di(montan wax acid) ester of 1,3-butanediol, montan wax acids, 1,3-butanediol, calcium montanate, and the calcium salt.

A preferred polymer additive is a derivative of an aromatic di- or tricarboxylic (ester) amide.

A preferred derivative is N,N′-bispiperidyl-1,3-benzenedicarboxamide.

Another preferred derivative is N,N′-bis(2,2,6,6-tetramethyl-4-piperidyl)-1 ,3-benzenedicarboxamide.

A preferred ratio in which wax and polymer additive are used in the inventive process is from 1:9 to 9:1 by weight.

Another preferred ratio in which wax and polymer additive are used in the inventive process is from 3:7 to 7:3 by weight.

Another preferred ratio in which wax and polymer additive are used in the inventive process is from 4.5:5.5 to 5.5:4.5 by weight.

The polycondensate is preferably polyamide.

The polyamides are preferably of amino-acid type and/or of diamine-dicarboxylic-acid type.

The polyamides are preferably nylon-6 and/or nylon-6,6.

The polyamides are preferably unmodified, colored, filled, unfilled, reinforced, or unreinforced polyamides, or else polyamides which have been otherwise modified.

It is preferable to use wax and polymer additive in the form of pellets, flakes, fine grains, powder, and/or micronizate.

Wax and polymer additive are preferably introduced in the same or different steps of the process during the preparation/processing of polyamides.

Wax and polymer additive are preferably incorporated during polycondensation, during the compounding process, or directly during the shaping process.

It is preferable to use wax and polymer additive individually, in the form of a physical mixture of the solids, in the form of a melt mixture, in the form of a compactate, or in the form of a masterbatch.

The total amount used of wax and polymer additive is preferably from 0.01 to 10.00% by weight, based on the polyamide.

The total amount used of wax and polymer additive is particularly preferably from 0.1 to 2.00% by weight, based on the polyamide.

Suitable lubricants for the inventive process are montan waxes, which may be described as a mixture of a long-chain linear saturated carboxylic acid having from 24 to 36 carbon atoms with various esters of this carboxylic acid with different alcohols, and with the salts of the carboxylic acids. They often comprise native montan wax, i.e. the ester of a. long-chain carboxylic acid with a long-chain monohydric alcohol.

Use is also made of esters of montan wax acid with glycol, glycerol, butanediol (1,3- and 1,4-), trimethylolpropane, pentaerythritol, and dipentaerythritol, and partially hydrolyzed products of these. The hydrolysis number of these products may be varied, as may their acid number and, where appropriate, their metal content.

Preferred montan waxes which may be used for the inventive process are products of the reaction of montan wax acid or, respectively, a mixture of native montan wax esters and of montan wax acids, with ethylene glycol to give a mixture of the mono- and diester and of the starting materials (e.g. ®Licowax E, Clariant GmbH). The calcium salt of the montan wax acids is also particularly suitable. This product is a product of the reaction of montan wax acid or, respectively, a mixture of native montan wax esters and of montan wax acids, with a calcium salt to give a mixture of calcium montanate and the starting materials (e.g. ®Licomont CaV 102, Clariant GmbH).

Preferred polymer additives which may be used for the inventive process comprise compounds of the type represented by the aromatic di- or tricarboxylic esters or aromatic di- or tricarboxamides. In particular, it has been found that substituted substances of the type represented by N,N′-bispiperidyl-1,3-benzenedicarboxamide, such as N,N′-bis(2,2,6,6-tetramethyl4-piperidyl)-1,3-benzenedicarboxamide (Nylostab® S-EED, Clariant GmbH) are suitable.

When the inventive process for polycondensates (polyamides) uses waxes and polymer additives, the level of internal and external lubricant action is increased, and the flowability is improved. Another result is very powerful release action and a marked reduction in the tendency of the polyamide molding composition to adhere to hot components of machines.

The use of wax and polymer additive according to the present invention also markedly improves the optical properties of a polyamide molding (surface gloss).

In the inventive process for preparing polycondensates in pigment masterbatches using polyamide as carrier material, the use of wax and polymer additive improves properties, in particular those concerned with finer and more uniform distribution of pigments and fillers, this being discernable through a markedly lower filter pressure Value, and also through increased color strength.

The inventive process for preparing polycondensates incorporates pulverulent or fine-grain substances via mixing or adsorption of these onto the cold or warm carrier polymer, and then processing through a molding step (e.g. injection molding, flat-film production, calendering), or, respectively, through prior compounding by means of an extruder, where wax or, respectively, polymer additive may be metered by means of lateral feed, or may be previously incorporated by mixing into the polyamide.

### EXAMPLES

The release action (external lubricant action) of lubricants in engineering plastics, such as polyamide, is quantified via measurement of demolding force during injection molding. For this, the cylindrical shell is produced by the injection-molding process, and the demolding force recorded is the maximum force needed to demold the shell from the mold. The lower the demolding force, the better the external lubricant action of the lubricant used.

The studies used a specific grade of nylon-6 in which no lubricants of any kind are present, the result being that this grade cannot be processed until lubricants have been added. The demolding force is >10 000 N. The lubricants and additives were incorporated by mixing into the polymer pellet, and by means of compounding in a twin-screw extruder, followed, after predrying, by injection molding.

All of the experiments were carried out under identical conditions (temperature programs, screw geometries, injection-molding parameters, etc.) for reasons of comparability.

### Example 1 (Release Action (External Lubricant Action))

Nylon-6, unreinforced

| | |
|---|---|
| 0.15 phr of Nylostab S-EED* + 0.15 phr calcium | 400 N |
| montanate Comparison: | |
| Nylon-6 without lubricant | >10 000 N |
| 0.3 phr Nylostab S-EED* | 1 500 N |
| 0.3 phr calcium montanate | 550 N |
| 0.3 phr montan wax ester | 550 N |

(*Nylostab S-EED is N,N-bis(2,2,6,6-tetramethyl-4-piperidyl)-1,3-benzenedicarboxamide)

Nylon-6, glass-fiber-reinforced

| | |
|---|---|
| 0.15 phr Nylostab S-EED + 0.15 phr calcium montanate | 850 N |
| 0.15 phr Nylostab S-EED + 0.15 phr montan wax ester | 800 N |
| Comparison: | |
| Nylon-6 (30% glass fiber) without lubricant | 2 500 N |
| 0.3 phr calcium montanate | 1 000 N |
| 0.3 phr montan wax ester | 900 N |

The improvement in flow (internal lubricant action) provided by lubricants in engineering plastics, such as polyamide, is usually quantified by determining the flow distance by means of a “spiral test”. For this, a graduated spiral is produced by the injection-molding process, and its length is determined. The longer the flow path (i.e. the spiral), the better the internal lubricant action, i.e. the flowability of the polymer.

Operations were carried out as in example 1, and use was made of the specific polyamide of example 1.

### Example 2 (Flow Improvement in Polyamide (Internal Lubricant Action))

| | |
|---|---|
| 0.15 phr Nylostab S-EED + 0.15 phr calcium montanate | 42.0 cm |
| Comparison: | |
| 0.3 phr Nylostab S-EED | 40.5 cm |
| 0.3 phr calcium montanate | 41.0 cm |

This flow improvement could not be achieved by any of the lubricants known from the prior art.

Gloss determination uses a reflectometer in which the reflected light is measured for a particular angle of incidence (reflection angle). According to DIN 67530, surfaces which, as in the present case, exhibit Values above 70 units at a 60° reflection angle are to be tested at a reflection angle of 200. The following Values were obtained on measurement at a reflection angle of 20°: the injection-molded plaques for the gloss measurement were produced under constant conditions, for reasons of comparability.

### Example 3

### Gloss of Compounded Polyamide Materials

| | |
|---|---|
| 0.15 phr Nylostab S-EED/0.15 phr calcium montanate | 89 gloss units |
| Comparison: | |
| Nylon-6 without lubricant | 87 gloss units |
| 0.3 phr Nylostab S-EED | 65 gloss units |
| 0.3 phr calcium montanate | 70 gloss units |

Specifically in the case of masterbatches using engineering plastics, such as polyamide, montan waxes are used as dispersing agents to wet the pigments, in order to comminute the pigments, which tend to agglomerate and are difficult to disperse. This effect is quantified by way of what is known as the filter pressure test, in which the pressure increase upstream of a filter of particular mesh width is measured, the increase being greater as the size of the agglomerates increases with the result that they block the filter. Pigments which have been better dispersed have better capability to pass through the filter, and dispersion quality is higher. A small filter-pressure value measured in [bar/g of pigment] is therefore a measure of good dispersing action of the lubricants.

PV Fast Pink was chosen as pigment, because it has low dispersibility in polyamide. Additive-free nylon-6 was used as carrier, and it was therefore possible to study the isolated action of the additives added. Surprisingly, it was found here that the inventive combinations composed of wax (montan waxes, such as montan wax esters or calcium montanate) and a polymer additive (® Nylostab S-EED) give extremely good dispersion,.i.e. give low filter-pressure Values, this dispersion not being achievable through any other combination.

The pigments and additives were incorporated by means of cold mixing and by compounding in a twin-screw extruder. The pressure-filter Value was then determined by way of a 14 μm filter.

### Example 4

### Dispersion of Pigments in Polyamides

| | | | | | | | | |
|---|---|---|---|---|---|---|---|---|
| Unreinforced | 60% | 60% | 60% | 65% | 65% | 65% | 65% | 65% |
| nylon-6 | | | | | | | | |
| PV Fast Pink E | 30% | 30% | 30% | 30% | 30% | 30% | 30% | 30% |
| Nylostab | 5% | 5% | | | | | | |
| S-EED | | | | | | | | |
| Calcium | 5% | | 10% | | | | | |
| montanate | | | | | | | | |
| Montan wax | | 5% | | 5% | | | | |
| ester | | | | | | | | |
| Licowax OP | | | | | 5% | | | |
| Licolub WE 40 | | | | | | 5% | | |
| Licolub WE 4 | | | | | | | 5% | |
| Ceridust ® | | | | | | | | 5% |
| 5551 | | | | | | | | |
| Filter-pressure | 4.0 | 3.6 | 18.0 | 6.0 | 11.4 | 13.4 | 12.0 | 16.6 |
| value [bar/g of | | | | | | | | |
| pigment] | | | | | | | | |

1. A process for preparing polycondensate comprising the step of adding at least one wax and at least one polymer additive during the preparation of the polycondensate, wherein the at least one wax and at least one polymer additive act as lubricants release agents or dispersing agents, and wherein the at least one wax is the products of the reaction of montan wax acids with ethylene glycol, or the products of the reaction of montan wax acids with a calcium salt, and the at least one polymer additive is a derivative of an aromatic di- or tricarboxylic (ester) amide.

2. The process as claimed in claim 1, wherein the products of the reaction of montan wax acids with ethylene glycol are a mixture of the mono(montan wax acid) ester of ethylene glycol, the di(montan wax acid) ester of ethylene glycol, montan wax acids, and ethylene glycol.

3. The process as claimed in claim 1, wherein the products of the reaction of montan wax acids with a calcium salt are a mixture of the mono(montan wax acid) ester of 1,3-butanediol, the di(montan wax acid) ester of 1,3-butanediol, montan wax acids, 1,3-butanediol, calcium montanate, and the calcium salt.

4. The process as claimed in claim 1, wherein the derivative of an aromatic di- or tricarboxylic (ester) amide is selected from the group consisting of N,N′-bispiperidyl-1,3-benzenedicarboxamide N,N′-bis(2,2,6,6-tetramethyl-4-piperidyl)-1,3-benzenedicarboxamide and mixtures thereof.

5. The process as claimed in claim 1, wherein the at least one wax and the at least one polymer additive are present in a ratio by weight of from 1:9 to 9:1.

6. The process as claimed in claim 1, wherein the at least one wax and the at least one polymer additive are present in a ratio by weight of from 3:7 to 7:3.

7. The process as claimed in claim 1, wherein the at least one wax and the at least one polymer additive are present in a ratio by weight of from 4.5:5.5 to 5.5:4.5.

8. The process as claimed in claim 1, wherein the polycondensate is polyamide.

9. The process as claimed in claim 8, wherein the polyamide is selected from the group consisting of the amino-acid type, the diamine-dicarboxylic-acid type and mixtures thereof.

10. The process as claimed in claim 8, wherein the polyamide is selected from the group consisting of nylon-6, nylon-6,6 and mixtures thereof.

11. The process as claimed in claim 8, wherein the polyamide is selected from the group consisting of unmodified, modified, colored, filled, unfilled, reinforced, or unreinforced polyamides.

12. The process as claimed in claim 1, wherein the at least one wax and the at least one polymer additive in the form selected from the group consisting of pellets, flakes, fine grains, powder, micronizate and mixtures thereof.

13. (Cancelled)

14. (Cancelled)

15. The process as claimed in claim 1, wherein the at least one wax and the at least one polymer additive individually, are in the form selected from the group consisting of a physical mixture solids, a melt mixture, a compactate, and a masterbatch.

16. The process as claimed in claim 1, wherein the at least one wax and the at least one polymer additive are present in an amount from 0.01 to 10.00% by weight, based on the polycondensate.

17. The process as claimed in claim 1, wherein the at least one wax and the at least one polymer additive are present in an amount from 0.1 to 2.00% by weight, based on the polycondensate.

18. A polycondensate made in accordance with the process of claim 1.

19. A process for producing a polycondensate comprising the steps of:
polycondensing at least two compounds to form a polycondensate;
compounding the polycondensate;
shaping the polycondensate;
adding, in a first adding step, at least one wax, wherein the at least one wax is the products of the reaction of montan wax acids with ethylene glycol, or the products of the reaction of montan wax acids with a calcium salt;
adding, in a second adding step, at least one polymer additive, wherein the at least one polymer additive is a derivative of an aromatic di- or tricarboxylic (ester) amide; and
wherein the first adding step, and the second adding step, individually, are performed during the polycondensing, compounding, and/or shaping step.
